(19) United States
(12) Patent Application Publication
(10) Pub. No.: US 2008/0133313 A1
(43) Pub. Date: Jun. 5, 2008

(54) IMPROVED METHODS AND SYSTEMS FOR FORECASTING PRODUCT DEMAND USING PRICE ELASTICITY

(76) Inventors: Arash Bateni, Toronto (CA); Edward Kim, Toronto (CA); Philip Liew, Markham (CA); Jean-Philipe Vorsanger, Toronto (CA)

Correspondence Address: James M. Stover;Intellectual Property Section, NCR Corporation, Law Department, 1700 South Patterson Blvd., Dayton, OH, 45479-0001, US

(21) Appl. No.: 11/566,357

(22) Filed: Dec. 4, 2006

(51) Int. Cl. G06Q 10/00

(52) U.S. Cl. 705/10

(57) ABSTRACT

An improved method for forecasting and modeling product demand for a product. The forecasting methodology blends information about the future price of a product with historical sales data to better forecast the future product demand. This forecasting methodoloy takes into account three main parameters that may affect the future demand for a product: seasonality (using seasonal factors), recent sales trends (through average rate of sale analysis) and the product price (by estimating the price driven demand).

### FIELD OF THE INVENTION

The present invention relates to methods and systems for forecasting product demand for retail operations, and in particular to the forecasting of future product demand for products experiencing price changes.

### BACKGROUND OF THE INVENTION

Accurately determining demand forecasts for products are paramount concerns for retail organizations. Demand forecasts are used for inventory control, purchase planning, work force planning, and other planning needs of organizations. Inaccurate demand forecasts can result in shortages of inventory that are needed to meet current demand, which can result in lost sales and revenues for the organizations. Conversely, inventory that exceeds a current demand can adversely impact the profits of an organization. Excessive inventory of perishable goods may lead to a loss for those goods.

Teradata, a division of NCR Corporation, has developed a suite of analytical applications for the retail business, referred to as Teradata Demand Chain Management (DCM), that provides retailers with the tools they need for product demand forecasting, planning and replenishment. Teradata Demand Chain Management assists retailers in accurately forecasting product sales at the store/SKU (Stock Keeping Unit) level to ensure high customer service levels are met, and inventory stock at the store level is optimized and automatically replenished. Teradata DCM helps retailers anticipate increased demand for products and plan for customer promotions by providing the tools to do effective product forecasting through a responsive supply chain.

As illustrated in FIG. 1, the Teradata Demand Chain Management analytical application suite 101 is shown to be part of a data warehouse solution for the retail industries built upon NCR Corporation's Teradata Data Warehouse 103, using a Teradata Retail Logical Data Model (RLDM) 105. The key modules contained within the Teradata Demand Chain Management application suite 101, are:

Contribution: Contribution module 111 provides an automatic categorization of SKUs, merchandise categories and locations based on their contribution to the success of the business. These rankings are used by the replenishment system to ensure the service levels, replenishment rules and space allocation are constantly favoring those items preferred by the customer.

Seasonal Profile: The Seasonal Profile module 112 automatically calculates seasonal selling patterns at all levels of merchandise and location. This module draws on historical sales data to automatically create seasonal models for groups of items with similar seasonal patterns. The model might contain the effects of promotions, markdowns, and items with different seasonal tendencies.

Demand Forecasting: The Demand Forecasting module 113 provides store/SKU level forecasting that responds to unique local customer demand. This module considers both an item's seasonality and its rate of sales (sales trend) to generate an accurate forecast. The module continually compares historical and current demand data and utilizes several methods to determine the best product demand forecast.

Promotions Management: The Promotions Management module 114 automatically calculates the precise additional stock needed to meet demand resulting from promotional activity.

Automated Replenishment: Automated Replenishment module 115 provides the retailer with the ability to manage replenishment both at the distribution center and the store levels. The module provides suggested order quantities based on business policies, service levels, forecast error, risk stock, review times, and lead times.

Time Phased Replenishment: Time Phased Replenishment module 116 Provides a weekly long-range order forecast that can be shared with vendors to facilitate collaborative planning and order execution. Logistical and ordering constraints such as lead times, review times, service-level targets, min/max shelf levels, etc. can be simulated to improve the synchronization of ordering with individual store requirements.

Allocation: The Allocation module 115 uses intelligent forecasting methods to manage pre-allocation, purchase order and distribution center on-hand allocation.

Load Builder: Load Builder module 118 optimizes the inventory deliveries coming from the distribution centers (DCs) and going to the retailer's stores. It enables the retailer to review and optimize planned loads.

Capacity Planning: Capacity Planning module 119 looks at the available throughput of a retailer's supply chain to identify when available capacity will be exceeded.

The Teradata Demand Chain Management suite of products described above models historical sales data to forecast future demand of products. The DCM application currently employs two processes in the determination of product demand forecasts: seasonal adjustments of product sales patterns, and extrapolation of demand using exponential moving average. The effect of product price on product demand, referred to as price elasticity, is not included in the forecasting methodology currently employed in the DCM application.

The forecasting methodology described below, blends information about the future price of a product with historical sales data to better forecast the future product demand. The consideration of price elasticity in forecast determinations improves the accuracy and consistency of demand forecasts when information about the future price of products is available.

### BRIEF DESCRIPTION OF THE DRAWINGS

FIG. 1 provides an illustration of a forecasting, planning and replenishment software application suite for the retail industries built upon NCR Corporation's Teradata Data Warehouse.

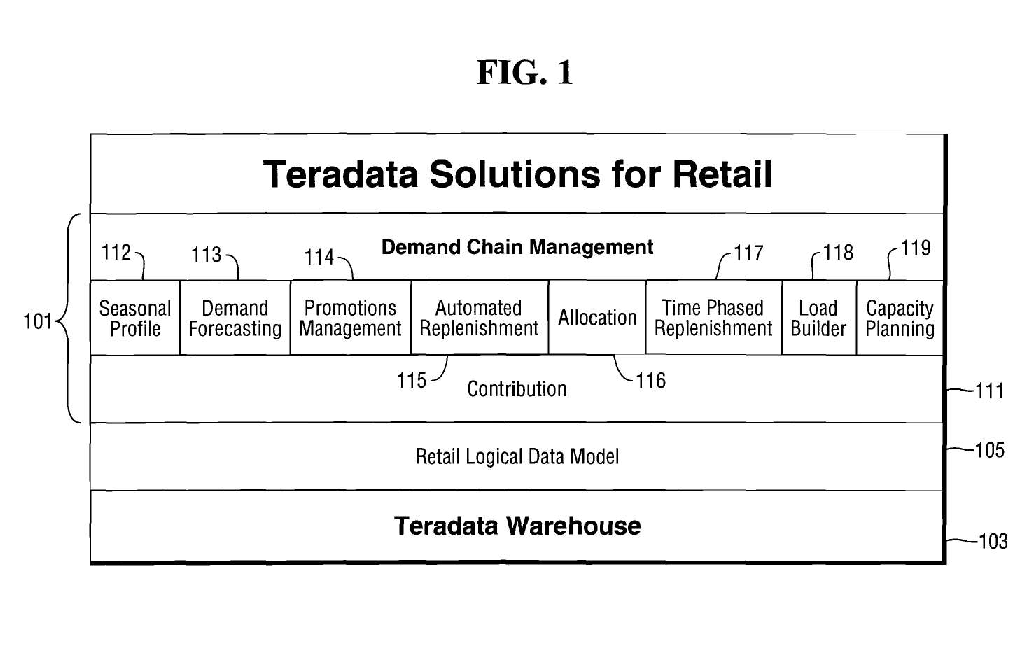

FIG. 2 provides a graph illustrating the effect of product price changes on product sales volume.

FIG. 3 provides a chart displaying price elasticity coefficients calculated for the pricing and sales data displayed in FIG. 2.

FIG. 4 provides a scatter plot displaying demand versus price for the pricing and sales data displayed in FIG. 2.

FIG. 5 is a flow chart illustrating a method for estimating product demand forecasts in accordance with the present invention.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable one of ordinary skill in the art to practice the invention, and it is to be understood that other embodiments may be utilized and that structural, logical, optical, and electrical changes may be made without departing from the scope of the present invention. The following description is, therefore, not to be taken in a limited sense, and the scope of the present invention is defined by the appended claims.

The demand forecasting technique described herein blends the results of product price elasticity analysis with current DCM forecast techniques including seasonal adjustments of product sales patterns, and extrapolation of demand using exponential moving average. The resulting hybrid method can estimate the demand change of a product due to a temporary or permanent shift in the price, improving demand forecast accuracy when the future price change of a product is known.

The new technique employs the following steps to forecast the demand of a product:
1. Deseasonalize historical product sales data.
2. Calculate the price elasticity of demand.
3. Estimate the price driven demand, i.e., the expected change in demand due to future price changes.
4. Extrapolate recent sales trends by calculation of Average Rate of Sales (ARS).
5. Forecast the demand by blending the calculated ARS and the price driven demand.

Methods for calculating ARS and seasonal adjustments are currently employed by the DCM Demand Forecasting application. The determination of the price elasticity of demand and inclusion of price elasticity in the DCM demand forecasting process is described below.

### Calculating Price Elasticity

Generally two different approaches are available for calculation of price elasticity using historical demand data: a) a local approach that calculates an elasticity coefficient every time the price changes and averages the elasticity over the calculated coefficients, and b) a global approach that calculates the demand-price correlation using regression analysis.

The local approach relies on the following fundamental relation:

$${E}_{d}^{( i )} = \frac{( {Q}_{i} - {Q}_{i - 1} ) / \frac{1}{2} ( {Q}_{i} + {Q}_{i - 1} )}{( {P}_{i} - {P}_{i - 1} ) / \frac{1}{2} ( {P}_{i} + {P}_{i - 1} )} \qquad EQN 1$$

where E_{d}⁽ⁱ⁾ is the local price elasticity corresponding to week i, Q is the quantity demanded and P is the unit price of the product. The above relationship is discussed in Ivan Png, “Managerial Economics”, Blackwell Publishing, 2001, ISBN 0631225161.

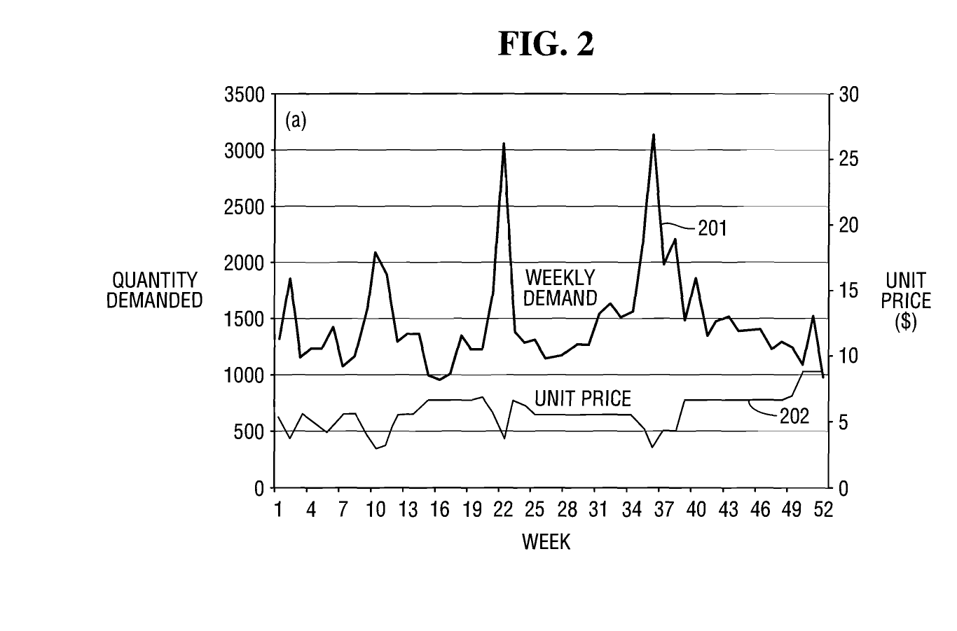

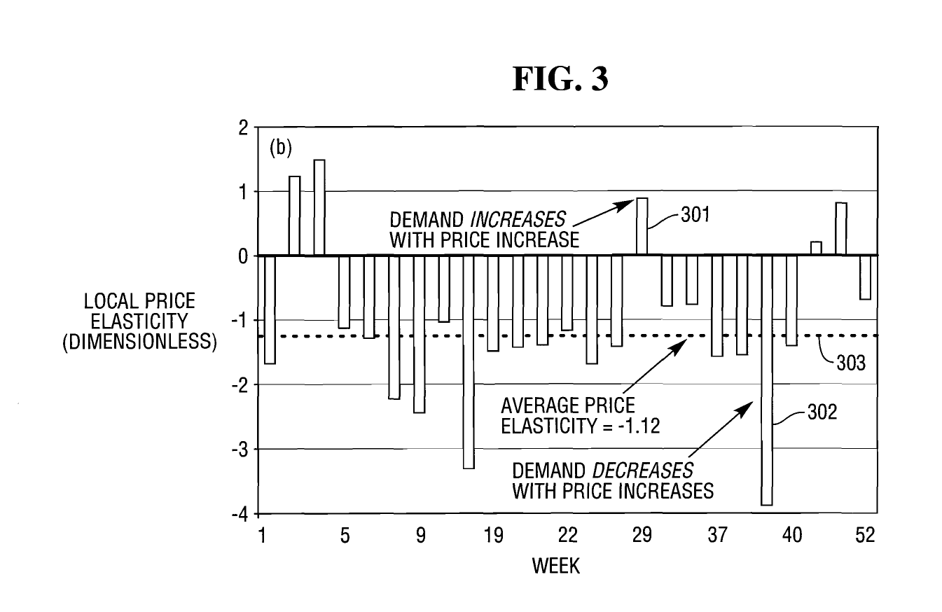

The overall price elasticity is then calculated by averaging over the available observations. As an illustration, FIG. 2 shows the sequence plot of price 202 and quantity demanded 201 over a 52 week period. FIG. 3 shows the local price elasticity coefficients, e.g., 301 and 302, and average price elasticity 303 calculated for the data shown in FIG. 2. Note that the negative average elasticity suggests that the demand generally increases with decreasing the unit price, as expected. Histogram 301 illustrates a somewhat rare occurrence where product demand increases with a price increase. Histogram 302 illustrates the more common relationship between product price and demand where demand decreases with a price increase.

Alternatively, price elasticity can be calculated globally using the analysis of regression. Analysis of regression techniques are discussed in Ronald E. Walpole, Raymond H. Myers, Sharon L. Myers, “Probability and Statistics for Engineers and Scientists”, 6^{th} Edition, Prentice Hall, 1998, ISBN 0138402086.

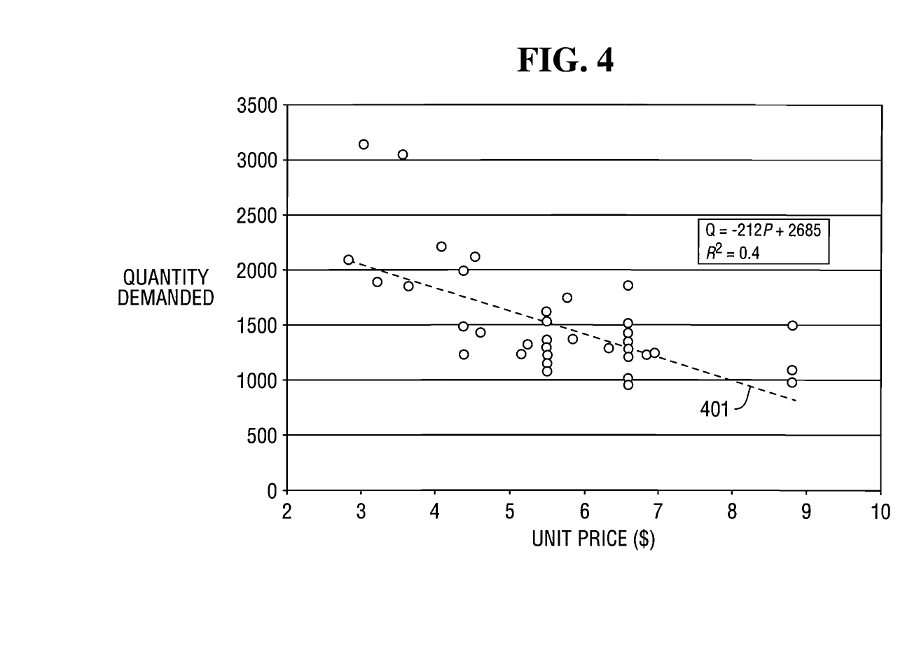

FIG. 4 shows the scatter plot of demand versus price for the data shown above in FIGS. 2 and 3. The fitted regression line 401 shows a negative correlation between quantity demand and unit price. The correlation coefficient, R², is a measure of the quality of the linear model. The equation of the fitted line globally relates the product demand to its unit price. This equation in general, and the slope (elasticity) in particular, can be used to forecast product demand. Note that the sequence of observations is neglected in the global approach. Details of the linear regression analysis are well known in the art.

### Estimating the Price Driven Demand

The price driven demand—the expected change in demand due to a price change—can be estimated using the price elasticity coefficient. Where the price elasticity is calculated locally the future demand quantity can be estimated as:

$${Q}_{i + 1}^{p} = {Q}_{i} + {E}_{d} \frac{( {P}_{i + 1} - {P}_{i} )}{( {P}_{i + 1} + {P}_{i} )} {Q}_{avr} \qquad EQN 2$$

where Q^{p}ᵢ₊₁ and Pᵢ₊₁ are the estimated price driven demand and the expected product price for the upcoming period, Qᵢ is the actual demand of the last period, and Qₐᵥᵣ is the historical average of product demand.

When the price elasticity is calculated globally, the equation of the fitted regression line is used to estimate the price driven demand:

Qᵢ₊₁^{p}=Q₀+E_{d}Pᵢ₊₁ EQN3

where Q₀ and E_{d} are the intercept and slope of the regression line (see FIG. 4).

### Forecasting the Demand

The product demand (Qᵢ₊₁) can be forecasted by blending the estimated price driven demand, (Q^{p}ᵢ₊₁) and the Average Rate of Sales (ARS) and applying the seasonal factors:

Qᵢ₊₁=(β.ARSᵢ₊₁+(1−β).Qᵢ₊₁^{p})SFᵢ₊₁, 0≦β≦1 EQN4

where SF and β are the seasonal and the blending factors, respectively.

This relation takes into account three main parameters that may affect the future demand: seasonality (using seasonal factors), recent sales trends (through ARS analysis) and the product price (by estimating the price driven demand). The blending factor, β, determines the relative importance of the recent patterns (ARS) versus the price elasticity in future demand. β may be calculated through an optimization (parameter estimation) process that minimizes the forecast error. It was found that generally the optimum blending factor for both the local and global approaches fall within the range of 0.1 to 0.25. The sensitivity of the forecast quality on the blending factor was investigated, suggesting a variation of less than 2% when β changes within the above range. Hence, when computational efficiency is of a concern, the sub-optimum value of β=0.2 can be used for all products. To maximize the forecast quality, β can be adjusted for individual products.

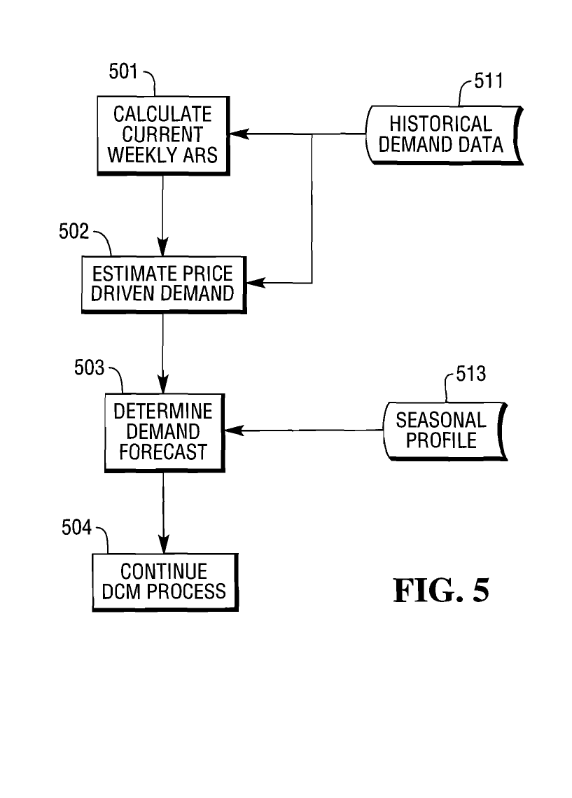

FIG. 5 is a flow chart illustrating a method for estimating product demand discussed above. As part of the demand forecasting process, historical demand data 511 is saved for each product or service offered by a retailer. The DCM demand forecasting process utilizes seasonal profiles 513, typically calculated at an aggregated level or class of the merchandise or product hierarchy, and Average Rates of Sales, determined though several methods, to determine product demand forecasts. A seasonal factor is calculated for each week of the fiscal year. The seasonal factor is calculated relative to an average week weight (1.0). For example, a seasonal factor of 2.0 means that sales for the measured period are expected to be twice that of an average period, whereas a seasonal factor of 0.8 means that sales for the measured period are expected to be 80% that of an average period.

In step 501 in FIG. 5, the current ARS for a product s calculated from historical demand data 511. Historical demand data 511 is also used in step 502 to determine the estimated price driven demand for the product. In step 503, the product demand forecast is determined by blending the estimated price driven demand from step 502, and the Average Rate of Sales (ARS) from step 502 and applying stored DCM application seasonal factors 513, in accordance with EQN4 provided above.

The foregoing description of various embodiments of the invention has been presented for purposes of illustration and description. It is not intended to be exhaustive or to limit the invention to the precise form disclosed. Many alternatives, modifications, and variations will be apparent to those skilled in the art in light of the above teaching. Accordingly, this invention is intended to embrace all alternatives, modifications, equivalents, and variations that fall within the spirit and broad scope of the attached claims.

What is claimed is:

1. A method for forecasting product demand for a product, the method comprising the steps of:
maintaining a database of historical product demand information;
analyzing said historical product demand information for said product to determine a price driven demand for said product;
analyzing said historical product demand information for said product to determine an average rate of sale for said product; and
blending said price driven demand for said product with said average rate of sale for said product to determine a product demand forecast for said product.

2. The method for forecasting product demand for a product in accordance with claim 1, further comprising the steps of:
analyzing said historical product demand information for said product to determine seasonal factors for said product; and
modifying said product demand forecast for said product through application of said seasonal factors.

3. The method for forecasting product demand for a product in accordance with claim 1, wherein said step of blending said price driven demand for said product (Q^{p}ᵢ₊₁) with said average rate of sale for said product (ARS) to determine a product demand forecast for said product (Qᵢ₊₁) comprises the step of:
determining said product demand forecast (Qᵢ₊₁) in accordance with the equation: Qᵢ₊₁=(β.ARSᵢ₊₁+(1−β).Q^{p}ᵢ₊₁), where β (beta) is a blending factor which determines the relative importance of the average rate of sale for said product (ARS) versus the price driven demand for said product (Q^{p}ᵢ₊₁) in future demand.

4. The method for forecasting product demand for a product in accordance with claim 3, wherein:
β (beta) is determined through a parameter estimation process to minimize forecast error in said product demand forecast.

5. The method for forecasting product demand for a product in accordance with claim 2, wherein said product demand forecast (Qᵢ₊₁) is determined in accordance with the equation: Qᵢ₊₁=(β.ARSᵢ₊₁+(1−β).Q^{p}ᵢ₊₁)SFᵢ₊₁, where β (beta) is a blending factor which determines the relative importance of the average rate of sale for said product (ARS) versus the price driven demand for said product (Q^{p}ᵢ₊₁) in future demand, and SFᵢ₊₁ is said seasonal factor.

6. The method for forecasting product demand for a product in accordance with claim 5, wherein:
β (beta) is determined through a parameter estimation process to minimize forecast error in said product demand forecast.
